(19) United States
(12) Patent Application Publication
(10) Pub. No.: US 2026/0351904 A1
(43) Pub. Date: Nov. 5, 2026

(54) CONNECTOR MULTI-POINT GROUND SHIELD TERMINAL WALLS

(71) Applicant: Molex, LLC, Lisle, IL (US)

(72) Inventors: David Arthur Burns, Brookfield, IL (US); Khang Choong Yong, Selangor (MY); John C. Laurx, Aurora, IL (US)

(21) Appl. No.: 19/577,374

(22) Filed: Mar. 25, 2026

Related U.S. Application Data
(60) Provisional application No. 63/792,340, filed on Apr. 22, 2025.

(51) Int. Cl. H01R 13/6585; H01R 12/73

(52) U.S. Cl. CPC H01R 13/6585; H01R 12/73

(57) ABSTRACT

Connectors with multi-point ground shield terminal walls and compliant shields are described. An example connector includes a housing with a slot for insertion of a board card edge interface and a wafer assembly positioned in the housing. The wafer assembly includes a channel shield and a pair of signal terminals that extend along a channel of the channel shield. The channel shield includes a channel floor wall, a pair of channel sidewalls, and a pair of multi-point contact ground shield terminal walls. Contact tip surfaces of the signal terminals and contact point surfaces of the ground shield terminal walls intersect a single contact tip plane when the board card edge interface is inserted into the slot of the housing. The connector can also include a compliant shield web positioned over the ground shield terminal walls and a compliant shield insert that extends along a channel sidewall.

### BACKGROUND

The amount of data processed by computers, computing systems, and computing environments continues to increase. Data centers, for example, can include hundreds of computing and networking systems interconnected using optical cables, copper cables, and a wide range of different connectors, cable assemblies, and terminations between them. The data throughput of these interconnect systems is high and increasing. As examples, many data centers incorporate a combination of 10 Gigabit Ethernet (10 GbE), 25 GbE, 50 GbE, and 100 GbE network interfaces and interconnects. 200 GbE, 400 GbE, and 800 GbE interconnection technologies are also being developed and deployed. Other interconnection solutions rely upon 56 Gigabit per second (Gb/s), 112 Gb/s, and 224 Gb/s interconnection technologies, and interconnection technologies are being developed to support higher data rates. A range of cable assemblies and connectors are available for the data interconnects. A variety of different designs exist for the cable assemblies and connectors.

It can be particularly challenging to design connectors for high data rate applications and interconnection systems due to a number of competing concerns. High data rate interconnection systems often rely upon differentially coupled signal pairs in which two conductors are arranged in a pair to transmit a differential signal. The signal being transmitted is embodied by the electrical voltage/current difference measured between the two conductors. Differential signaling can be helpful to avoid or reject spurious signals and crosstalk and to avoid inadvertent signaling modes among adjacent signal pairs. In connector interfaces, ground terminals can be relied upon to create a current return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the signal and ground terminal conductors in the wafer assemblies. The use of wafer assemblies can be helpful to manufacture connectors capable of achieving high data rates using a number of different assembly processes. It is still challenging, in any case, to design connectors having the size and conductor density needed for new systems, while also maintaining the electrical characteristics needed for the data rates and signal integrity specified by emerging industry standards and customer specifications.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures. An example connector includes a housing comprising a slot for insertion of a board card edge interface and a wafer assembly positioned in the housing. The wafer assembly can include a channel shield and a pair of signal terminals that extend along a channel of the channel shield. The channel shield can include a channel floor wall, a pair of channel sidewalls, and a pair of multi-point contact ground shield terminal walls. Contact tip surfaces of the pair of signal terminals and contact point surfaces of the pair of multi-point contact ground shield terminal walls can intersect a single contact tip plane when the board card edge interface is inserted into the slot of the housing.
In other aspects, the channel shield includes a channel floor wall and the pair of channel sidewalls, and the channel of the channel shield extends between the pair of sidewalls and over the channel floor. The pair of ground shield terminal walls of the channel shield can extend beyond an end edge of the channel floor wall in some cases. In other aspects, the channel shield can include a plurality of compliancy notches positioned along at least one multi-point contact ground shield terminal wall. The channel shield can also include a plurality of cantilever spring beams extending from an upper edge of at least one multi-point contact ground shield terminal wall.
In other aspects, the connector can also include a compliant shield web positioned over and across the pair of multi-point contact ground shield terminal walls. The compliant shield web can be embodied as an elastic, expandible and compressible material, such as conductive foam. The connector can also include a compliant shield insert that extends along a channel sidewall among the pair of channel sidewalls. The compliant shield insert can also be embodied as an elastic, expandible and compressible material, such as conductive foam.
The connector can also include a second channel shield including a second pair of multi-point contact ground shield terminal walls. The pair of multi-point contact ground shield terminal walls can include a first plurality of point contacts at first locations, and the second pair of multi-point contact ground shield terminal walls can include a second plurality of point contacts at second locations different than the first locations.
Another example connector includes a housing and a wafer assembly positioned in the housing. The wafer assembly includes a channel shield and a pair of signal terminals that extend along a channel of the channel shield. The channel shield includes a pair of multi-point contact ground shield terminal walls. Contact tip surfaces of the pair of signal terminals and of the pair of multi-point contact ground shield terminal walls are configured to intersect a single contact tip plane when a board card edge interface is inserted into the housing. The channel shield can also include a channel floor wall and a pair of channel sidewalls, and the channel of the channel shield can extend between the pair of sidewalls and over the channel floor.

An example wafer assembly includes a channel shield with a channel floor wall, a pair of channel sidewalls, and a pair of multi-point contact ground shield terminal walls. The wafer assembly also includes a pair of signal terminals that extend along a channel of the channel shield. Contact tip surfaces of the pair of signal terminals and contact point surfaces of the multi-point contact ground shield terminal walls are configured to intersect a single contact tip plane. The wafer assembly can also include a compliant shield web positioned over and across the pair of multi-point contact ground shield terminal walls. The wafer assembly can also include a compliant shield insert that extends along a channel sidewall among the pair of channel sidewalls.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example connector according to various embodiments of the present disclosure.

FIG. 1B illustrates the connector shown in FIG. 1A, mounted to a circuit board and mated with a board card edge interface, according to various embodiments of the present disclosure.

FIG. 2A illustrates the wafer assemblies of the connector shown in FIG. 1A, with the housing of the connector omitted from view, according to various embodiments of the present disclosure.

FIG. 2B illustrates components of a wafer assembly of the connector shown in FIG. 1A, with the components expanded apart from each other, according to various embodiments of the present disclosure.

FIG. 2C illustrates additional components of a wafer assembly of the connector shown in FIG. 1A, with the additional components expanded apart from each other, according to various embodiments of the present disclosure.

FIG. 2D illustrates components of another wafer assembly of the connector shown in FIG. 1A, with the components expanded apart from each other, according to various embodiments of the present disclosure.

FIG. 2E illustrates additional components of the other wafer assembly of the connector shown in FIG. 1A, with the additional components expanded apart from each other, according to various embodiments of the present disclosure.

FIG. 3A illustrates a top-down perspective view of two channel shields of the wafer assembly shown in FIG. 2A according to various embodiments of the present disclosure.

FIG. 3B illustrates a bottom-up perspective view of the two channel shields shown in FIG. 3A according to various embodiments of the present disclosure.

FIG. 4A illustrates a top-down perspective view of channel shields and terminal conductors of the wafer assembly shown in FIG. 2A according to various embodiments of the present disclosure.

FIG. 4B illustrates another top-down perspective view of channel shields and terminal conductors of the wafer assembly shown in FIG. 4A, with a card board edge interface inserted into the connector, according to various embodiments of the present disclosure.

FIG. 5A illustrates a side view of the channel shields and terminal conductors shown in FIG. 4A according to various embodiments of the present disclosure.

FIG. 5B illustrates a front view of the channel shields and terminal conductors shown in FIG. 5A according to various embodiments of the present disclosure.

FIG. 5C illustrates a back view of the channel shields and terminal conductors shown in FIG. 5A according to various embodiments of the present disclosure.

FIG. 6 illustrates side views of two channel shields according to various embodiments of the present disclosure.

FIG. 7 illustrates a side view of another example ground shield terminal wall of another channel shield according to various embodiments of the present disclosure.

FIG. 8 illustrates a side view of ground shield terminal walls in the connector shown in FIG. 1A according to various embodiments of the present disclosure.

### DETAILED DESCRIPTION

The amount of data processed by computers, computing systems, and computing environments continues to increase. Data centers, for example, can include hundreds of computing and networking systems interconnected using optical cables, copper cables, and a wide range of different connectors, cable assemblies, and terminations between them.

The small form-factor pluggable (SFP) module format is a compact, hot-pluggable network interface module format used for data interconnects, and SFP modules are commonly used for interconnects in data centers. An SFP interface on a computing or networking system is a modular slot for a media-specific transceiver, such as a copper or fiber-optic cable assembly. Cable assemblies can include SFP transceiver modules at one or both ends of a copper, fiber-optic, or other type of interconnecting cable. SFP transceiver modules can be inserted into SFP interfaces for data interconnections.

A range of SFP transceiver modules are currently available, such as small form-factor pluggable double density (SFP-DD), compact small form-factor pluggable (cSFP), SFP+, quad small form-factor pluggable (QSFP), quad small form-factor pluggable double density (QSFP-DD), octal small form factor pluggable (OSFP), and others. An active electrical cable (AEC) assembly can include an SFP transceiver module at the free end of cables or a cable bundle. An AEC assembly can include more printed circuit boards (PCBs) and semiconductor chips for signal re-timing, noise reduction, signal integrity improvement, and other functions. SFP transceiver modules often include one or more PCBs with semiconductor circuit devices or chips and other circuitry mounted to the PCBs. The PCBs can provide PCB-style tip interfaces at one end or side of the module, for insertion into a mating connector.

Connectors are often designed to meet a range of different electrical and mechanical requirements or specifications. Many connectors incorporate one or more wafer assemblies that are carefully designed to meet or exceed industry standards or related specifications. The use of wafer assemblies can be helpful to manufacture connectors capable of high data rates using a range of different assembly processes. It is still challenging, in any case, to design connectors having the size and conductor density needed for new systems, while also maintaining the electrical characteristics needed for the data rates and signal integrity specified by emerging industry standards and customer specifications.

In the context outlined above, various aspects and embodiments of connectors with multi-point ground shield terminal walls and compliant shields are described herein. An example connector includes a housing with a slot for insertion of a board card edge interface and a wafer assembly positioned in the housing. The wafer assembly includes a channel shield and a pair of signal terminals that extend along a channel of the channel shield. The channel shield includes a channel floor wall, a pair of channel sidewalls, and a pair of multi-point contact ground shield terminal walls. Contact tip surfaces of the signal terminals and contact point surfaces of the ground shield terminal walls intersect a single contact tip plane when the board card edge interface is inserted into the slot of the housing. The connector can also include a compliant shield web positioned over the ground shield terminal walls and a compliant shield insert that extends along a channel sidewall.

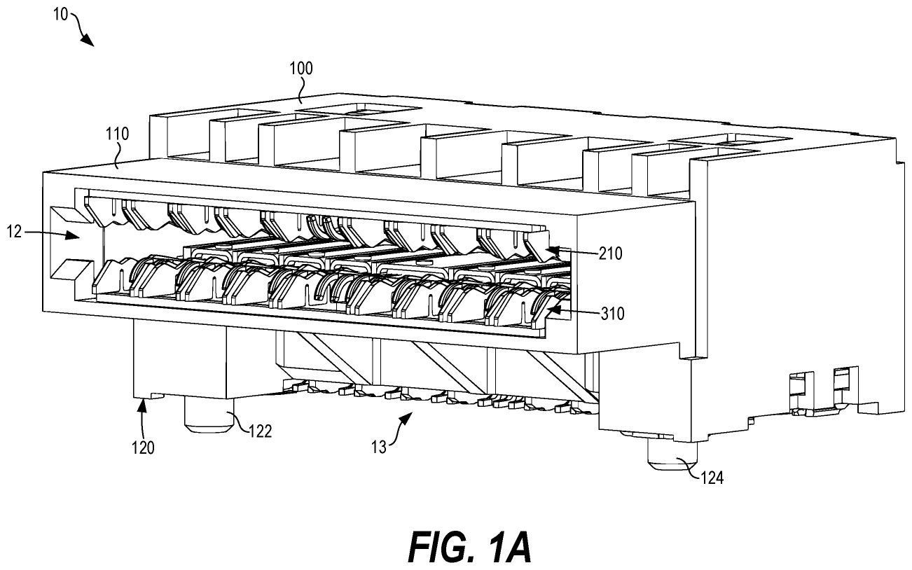

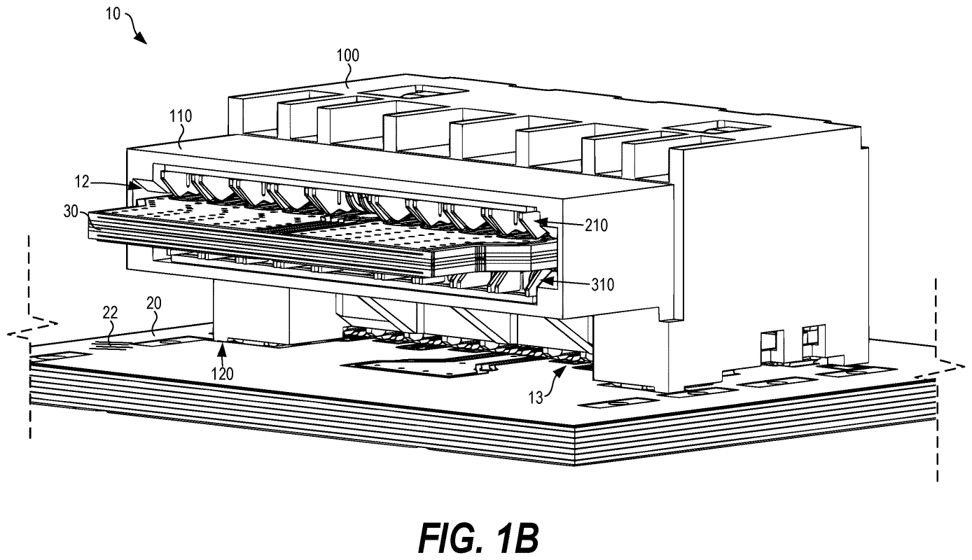

Turning to the drawings, FIG. 1A illustrates a perspective view of an example connector 10 according to various embodiments of the present disclosure. The connector 10 is illustrated as a representative example of a connector including multi-point ground shield terminal walls and compliant shields. The concepts described herein can be extended to use with a range of other connectors of different types, styles, and formats, however. The connector 10 is not drawn to any particular scale or size in the drawings. The shape, size, proportion, and other characteristics of the connector 10 can vary as compared to that shown. For example, the connector 10 can accommodate larger or smaller rows of terminal conductors (e.g., be wider or narrower), and other variations are within the scope of the examples described herein. A number of connectors similar to the connector 10 can be stacked or arranged side-by-side, for higher data rate interconnection systems. Additionally, one or more of the parts or components of the connector 10, as illustrated in the drawings and described herein, can be omitted in some cases. The connector 10 can also include other parts or components that are not illustrated.

The connector 10 includes a front port opening 12 and a terminal foot 13. The connector 10 is designed to establish and maintain robust electrical connections with contact pads on opposing sides of a board card edge interface regardless of the number of insertion/removal operations of the board card edge interface into the connector 10. As one example, the PCB-style tip of an SFP transceiver module can be inserted into the front port opening 12 of the connector 10, but the connector 10 can be used with mating card edge interfaces in a range of different modules, cable assemblies, and mating interfaces. The connector 10 includes two (2) rows of signal terminal conductors and ground shield terminal walls. The terminal conductors and ground shield walls are supported by wafer assemblies of the connector 10, as described in additional detail below. The terminal conductors and ground shield walls extend from the front port opening 12 to the terminal foot 13 of the connector 10, for the communication of data signals through the connector 10.

The connector 10 is designed to provide shielding and maintain the signal integrity of differential signals that are transmitted over the signal terminal conductors within the connector 10, as they extend from the front port opening 12 to the terminal foot 13. The connector 10 can be designed as a mating connector for use with SFP or related interconnection systems, as one example, although the connector 10 can be mated with other types of board card edge interconnection systems. The concepts described herein are also not limited to use with any particular type or style of interconnection system. The terminal foot 13 of the connector 10 can be designed as a surface mount technology (SMT) foot, for coupling to the surface of a PCB, but the connector 10 can also be designed to have through-hole or other lead styles of terminal conductors at the terminal foot 13. The connector 10 is shown mounted to a PCB in FIG. 1B. The concepts described herein can also be extended to connectors that incorporate bypass cables, and certain signal and ground terminal conductors of the connector 10 can be directly coupled to one or more twinax cables in some cases, for signal bypass applications.

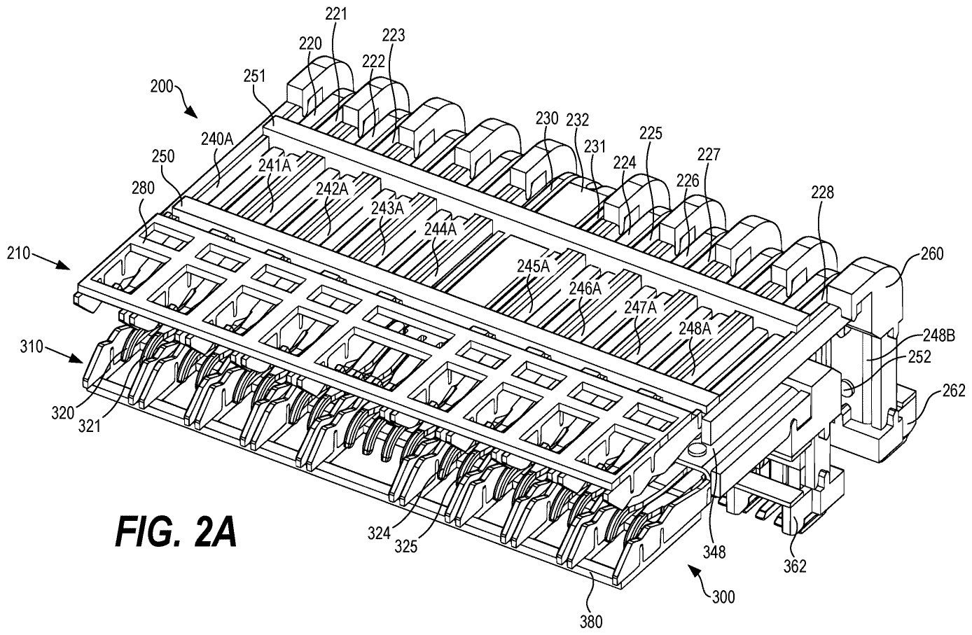

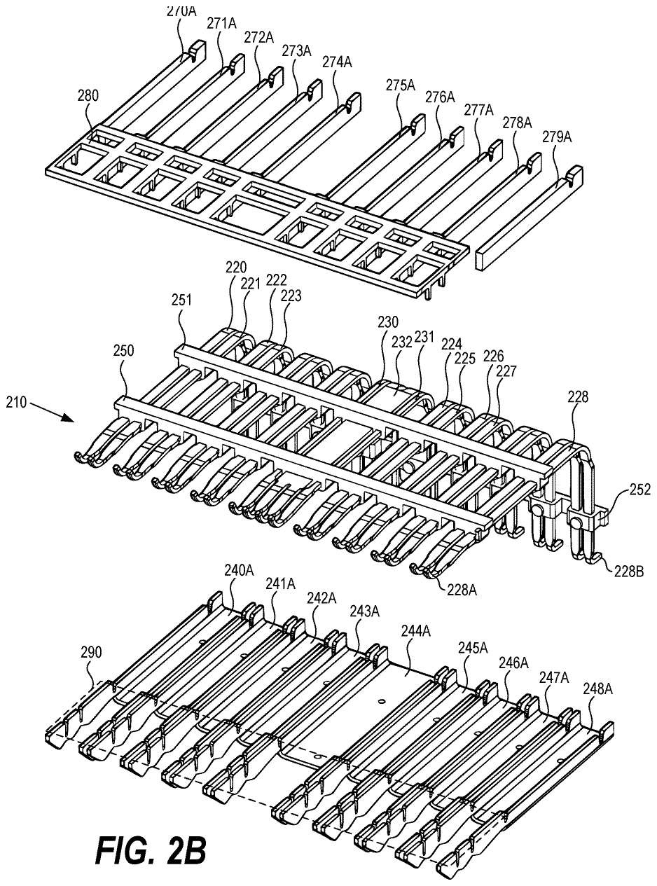

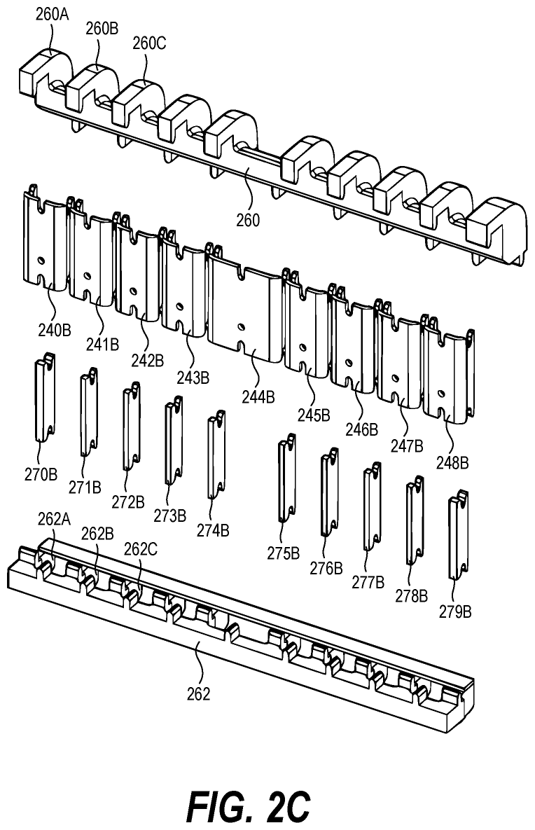

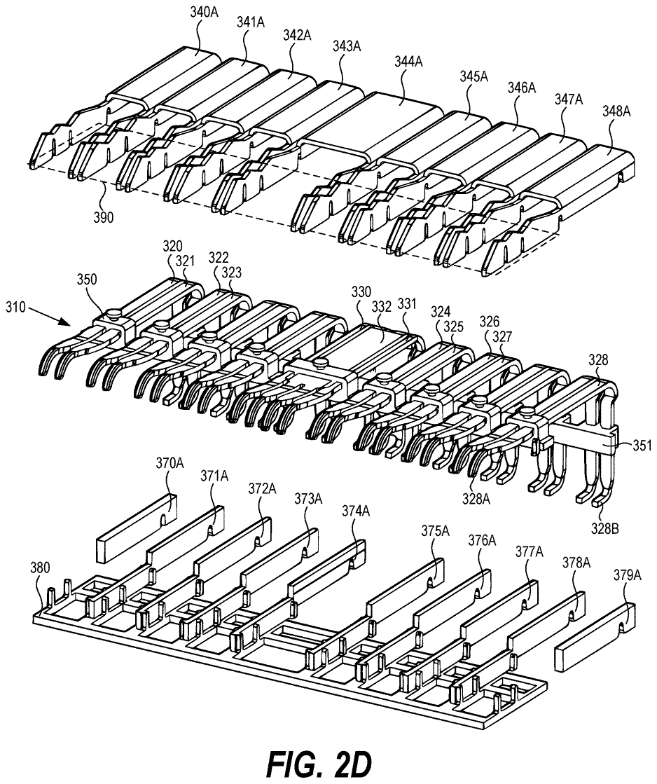

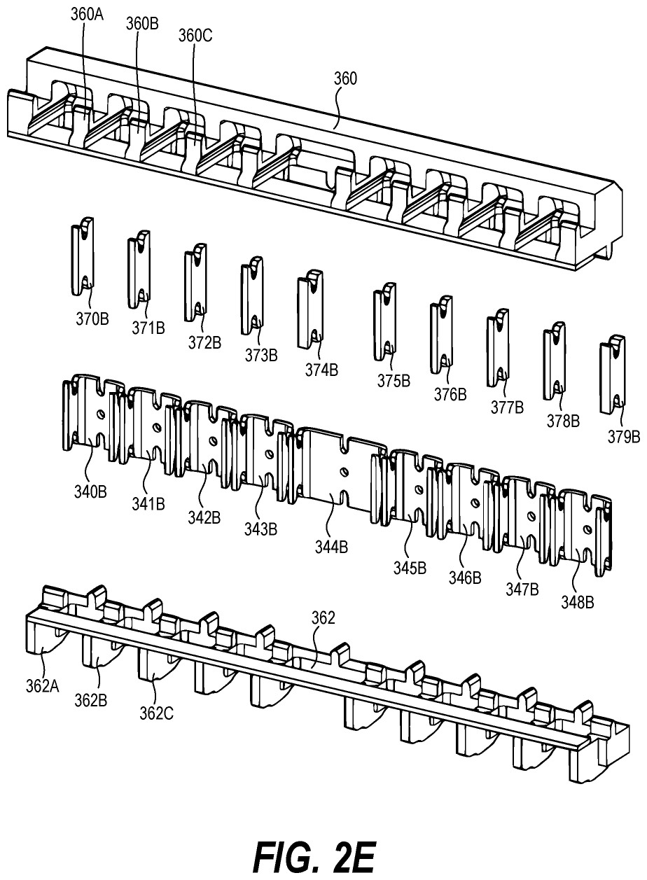

As shown in FIG. 1A, the connector 10 includes a housing 100 and rows 210 and 310 of terminal conductors and ground shield terminal walls. The terminal conductors and ground shield terminal walls in the rows 210 and 310 have contact tips, which are located within the front port opening 12. The ground shield terminal walls include multi-point contacts. The rows 210 and 310 are provided by upper and lower wafer assemblies, which are positioned and secured within the housing 100. The wafer assemblies are described in further detail below with reference to FIGS. 2A-2E. The row 210 is provided by the upper wafer assembly, and the row 310 is provided by the lower wafer assembly, as also described below.

The housing 100 can be formed from a plastic, polymer, or other insulating material, such as liquid crystal polymer (LCP), polyethylene (PE), polytetrafluoroethylene (PTFE), fluoropolymer, or other plastic or insulating material(s). The housing 100 can also be formed from metal or combinations of insulating and conductive materials in some cases. The housing 100 can be formed using any suitable additive or subtractive manufacturing techniques, including molding, injection molding, printing, and other techniques.

The housing 100 includes a front port 110, a bottom mounting surface 120, and mounting posts 122 and 124, among other features. The connector 10 can be configured to receive the PCB-style tip of an OSFP transceiver module, as one example, although the connector 10 can also receive other types of board card edge interfaces. When the PCB-style tip is inserted into the front port opening 12, the rows 210 and 310 of signal terminal conductors and ground shield terminal walls will contact, wipe against, and make electrical contact with contact pads on the top and bottom surfaces of the PCB-style tip.

The shielding for the signal terminal conductors in the rows 210 and 310 can be particularly important for the connector 10. Suitable electromagnetic interference (EMI) shielding can be necessary to meet the electrical characteristic and signal integrity specifications of emerging industry standards, as one example among other reasons. EMI shielding is important throughout the connector 10, including within the front port opening 12, at the terminal foot 13, and inside the body of the housing 100 between the front port opening 12 and the foot 13.

The connector 10 includes a number of channel shields having ground shield terminal walls. The ground shield terminal walls are used in place of ground terminal conductors, as commonly used in other connectors, in the connector 10. Each pair of signal terminal conductors in the rows 210 and 310 extends along and within a channel shield, between the front port opening 12 and the terminal foot 13 of the connector 10. At one end of a channel shield, the sidewalls of the channel shield are formed as extended ground shield terminal walls. The ground shield terminal walls include multi-point contacts at the one end. At the other end of the channel shield, the sidewalls of the channel shield are secured into channel inserts, as described below. The ground shield terminal walls are relatively larger in certain dimensions than the signal terminal conductors, and two ground shield terminal walls are positioned on opposite sides of each pair of signal terminal conductors. Compliant shields, webs, or sheets, which can be formed from conductive foam or elastomer pads, may also be inserted between the channel shields and/or attached over and across edges of the ground shield terminal walls. The ground shield terminal walls and compliant shields substantially surround each pair of signal terminal conductors in the connector 10, particularly when a PCB-style tip interface is inserted and fully seated into the front port opening 12 of the connector 10.

FIG. 1B illustrates the connector 10 shown in FIG. 1A, mounted to a PCB 20 and mated with a board card edge interface 30. The bottom mounting surface 120 of the connector 10 is seated upon the top surface 22 of the PCB 20. Although not visible in FIG. 1B, the mounting posts 122 and 124 of the connector 10 are inserted into apertures through the PCB 20, which helps to secure the connector 10 in place with respect to the PCB 20. The tail ends of the signal terminal conductors and the ground shield terminal walls in the rows 210 and 310 can be electrically coupled to contact pads on the top surface of the PCB 20 using solder, conductive adhesives, welds, or other means at the terminal foot 13 of the connector 10. In that way, differential data signals can be transmitted through the connector 10 to traces extending on and through the PCB 20.

FIG. 1B also illustrates the board card edge interface 30 inserted into the front port opening 12 of the connector 10. The board card edge interface 30 is representative of a PCB-style tip of an OSFP module, although other types of board card edge interfaces can be inserted into the front port opening 12. When the board card edge interface 30 is inserted into the front port opening 12 of the connector 10, the signal terminal conductors and ground shield terminal walls in the rows 210 and 310 make electrical contact with and wipe against contact pads on top and bottom surfaces of the board card edge interface 30. As discussed above, the shielding for the signal terminal conductors in the rows 210 and 310 can be particularly important for the connector 10. EMI shielding is important throughout the connector 10, including within the front port opening 12, at the terminal foot 13, and inside the body of the housing 100 between the front port opening 12 and the foot 13. The connector 10 includes channel shields having ground shield terminal walls. Compliant shields may also be inserted between the channel shields and/or positioned over edges of the ground shield terminal walls. The ground shield terminal walls and compliant shields substantially surround each pair of signal terminal conductors in the connector 10 and form EMI shield pockets over the board card edge interface 30. These and other aspects of the embodiments are described in further detail below.

FIG. 2A illustrates wafer assemblies 200 and 300 of the connector 10 shown in FIG. 1A, with the housing 100 of the connector 10 omitted from view. FIGS. 2B and 2C illustrate parts of the wafer assembly 200 expanded apart from each other. FIGS. 2D and 2E illustrate parts of the wafer assembly 300 expanded apart from each other. The wafer assembly 200 can be referred to as an upper wafer assembly in the connector 10, and the wafer assembly 300 can be referred to as a lower wafer assembly in the connector 10. The wafer assemblies 200 and 300 include terminal conductors (e.g., signal terminal conductors) for the communication of high-speed data signals, low-speed data signals, and power through the connector 10. The terminal conductors of the wafer assembly 200 can transfer data from the front port opening 12 to the terminal foot 13 of the connector 10 (e.g., be used for data reception), and the wafer assembly 300 can transfer data from the terminal foot 13 to the front port opening 12 of the connector 10 (e.g., be used for data transmission). However, the wafer assemblies 200 and 300 and the pairs of signal terminal conductors in the wafer assemblies 200 and 300 are not limited to any particular direction of data transfer and can be used in any combination of data reception and transmission, between the front port opening 12 to the terminal foot 13 of the connector 10.

Referring among FIGS. 2A-2C, the wafer assembly 200 includes signal terminal conductors 220-228, 230, and 231 (also “signal terminals 220-228, 230, and 231”), among others, a power terminal conductor 232 (also “power terminal 232” and collectively “terminals 220-228 and 230-232”), upper channel shields 240A-248A and lower channel shields 240B-248B (collectively “channel shields 240-248”), wafer molding inserts 250-252, channel inserts 260 and 262, compliant shield inserts 270A-279A and compliant shield inserts 270B-279B (collectively “compliant shield inserts 270-279”), and a compliant shield web 280. The compliant shield inserts 270-279 and compliant shield web 280 are examples of compliant shields, as referred to herein. The compliant shield inserts 270A-279A, or a number of the compliant shield inserts 270A-279A, can be attached or integral with the compliant shield web 280 in some cases. In the example shown, the compliant shield inserts 271A-278A attached or integral with the compliant shield web 280, and the compliant shield inserts 270A and 279A are separated from the compliant shield web 280. Other configurations or arrangements of the compliant shield inserts 270A-279A and the compliant shield web 280 are within the scope of the embodiments. The wafer assembly 200 is illustrated as a representative example in FIGS. 2A-2C, and the size, number, shape, and other aspects of the components of the wafer assembly 200 can vary as compared to that shown.

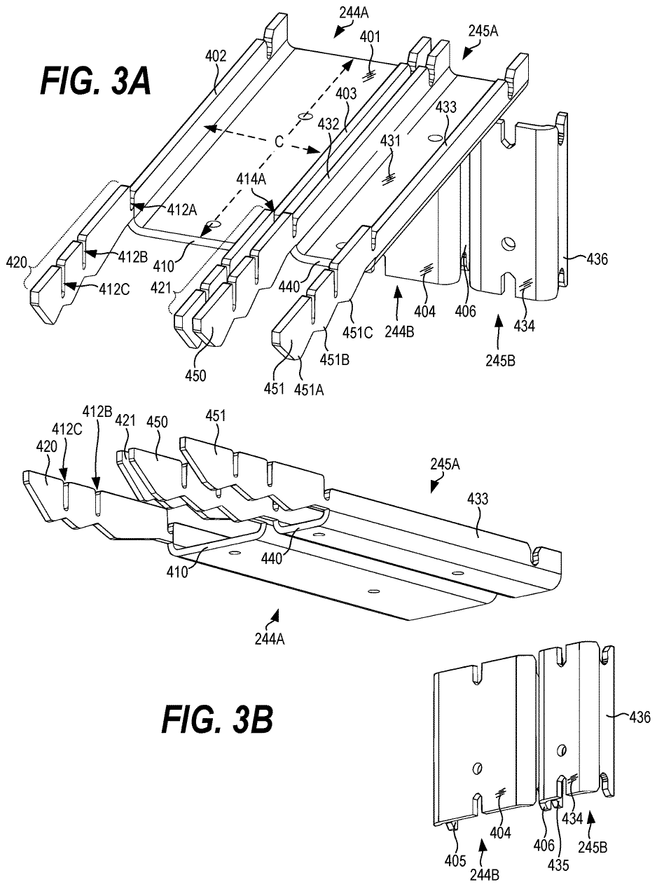

The terminals 220-228 and 230-232 can be formed (e.g., stamped, sheared, bent, and otherwise formed) from a flat sheet of metal or other conductive material. In some cases, the sheet of metal can be plated with one or more plating metals. Each of the channel shields 240-248 can also be formed (e.g., stamped, sheared, or otherwise formed) from a flat sheet of metal or other conductive material, which can be plated in some cases. Each of the channel shields 240-248 is bent or pressed into type of “U” or channel shape and includes a pair of ground shield terminal walls, as described in further detail below with reference to FIGS. 3A and 3B. The shape of the channel shields 240-248 can also vary as compared to that shown.

The terminals 220-228 and 230-232 can be formed in a row, extending alongside each other, at the same time from a single sheet of metal in one example. Each of the terminals 220-228 and 230-232 includes a lead or tip contact at one distal end (i.e., positioned in the front port opening 12 of the connector 10, as shown in FIG. 1A), a tail contact at another distal end (i.e., positioned at the terminal foot 13), and a terminal conductor body including a bend between the tip contact and the tail contact. For example, as shown in FIG. 2B, the signal terminal conductor 228 includes a tip contact 228A and a tail contact 228B. The tail contacts of the terminals 220-228 and 230-232 can be formed as SMT tail contacts, as in the example shown, as through-hole (e.g., eye-of-needle) tail contacts, or as other types of tail contacts. However, in other examples, the connector 10 can incorporate bypass cables, and the terminal conductor body of the terminals 220-228 and 230-232 can be directly coupled to one or more twinax cables for signal bypass applications.

The signal terminal conductors 220-228, among others in the wafer assembly 200, can be arranged and used in pairs of terminal conductors to transfer high-speed differential signals. For example, the conductors 220 and 221 can be relied upon as a first pair of signal terminal conductors for communicating a first high-speed differential signal, the conductors 222 and 223 can be relied upon as a second pair of signal terminal conductors for communicating a second high-speed differential signal, the conductors 224 and 225 can be relied upon as a third pair of signal terminal conductors for communicating a third high-speed differential signal, and so on. The signal terminal conductors 230 and 231, among possibly others in the wafer assembly 200, can be relied upon as a pair of signal terminal conductors for communicating a first low-speed differential signal. The power terminal conductor 232 can be relied upon to source or sink power, for example, such as for sinking or sourcing a direct current (DC) supply of power at 5V, 12V, or power at another potential.

The channel shields 240-248 form part of a shielding and grounding network for the signal terminals in the connector 10. Thus, the signal terminal conductors 220-228, 230, and 231, the power terminal conductor 232, and other terminal conductors of the wafer assembly 200 are arranged to extend within the channel shields 240-248, as shown in FIG. 2A. The terminal conductors 220-228 and 230-231 extend along and within the channels of the channel shields 240-248 in the wafer assembly 200. The pair of signal terminal conductors 220 and 221 shown in FIG. 2B, for example, are positioned and extend within the channel of the channel shield 240. In that arrangement, the channel shield 240 provides EMI shielding for the signal terminal conductors 220 and 221 and helps to reduce crosstalk and spurious signals between the signal terminal conductors 220 and 221 and other terminal conductors in the connector 10. In addition to EMI shielding, the channel shield 240 is designed to provide a return path sufficient to ensure suitable signal integrity for differential signals carried over the signal terminal conductors 220 and 221. The other channel shields 241-248 provide a similar purpose. For example, the pair of signal terminal conductors 222 and 223 are positioned and extend within the channel of the channel shield 241, the pair of signal terminal conductors 224 and 225 are positioned and extend within the channel of the channel shield 245, and so on. At the middle of the wafer assembly 200, the signal terminal conductors 230 and 231 and the power terminal conductor 232 are positioned and extend within the channel of the channel shield 244, which is wider than the other channel shields.

The wafer molding inserts 250-252 can be formed by injection molding. In one example, the terminal conductors 220-228 and 230-232, among others in the row 210, can be arranged and positioned in a mold along with the channel shields 240-248. The wafer molding inserts 250-252 can then be formed by the injection of a plastic, such as LCP or another insulating material(s), into the mold. The insulating material can flow around the terminal conductors 220-228 and 230-232 within the mold, to form the wafer molding inserts 250-252 at the locations shown in FIG. 2B.

The wafer molding inserts 250-252 serve a number of purposes in the wafer assembly 200. The wafer molding inserts 250-252 secure the terminal conductors 220-228 and 230-232 in place relative to each other. The wafer molding inserts 250-252 also electrically isolate the terminal conductors 220-228 and 230-232 from each other. When formed, the insulating material of the wafer molding inserts 250-252 can also flow through, or otherwise be inserted through, openings or apertures in the channel shields 240-248, and a heat staking process can be used to form staking caps of the wafer molding inserts 250-252. The staking caps locate and secure the wafer molding inserts 250-252 with the channel shields 240-248, as described in further detail below. Thus, when formed, the wafer molding inserts 250-252 secure the terminal conductors 220-228 and 230-232 within the channel shields 240-248, electrically isolate the terminal conductors 220-228 and 230-232 from each other, and electrically isolate the terminal conductors 220-228 and 230-232 from the channel shields 240-248.

The channel inserts 260 and 262 can be separately formed from a plastic or polymer, such as LCP, PE, PTFE, fluoropolymer, or other plastic or insulating material(s) in one example and assembled to the channel shields 240-248. The channel inserts 260 and 262 can also be formed from moldable metal material, using a die-cast, metal-injected molding, additive manufacturing methodology, or related approach. The channel insert 260 is positioned and secured between the upper channel shields 240A-248A and the lower channel shields 240B-248B, and the channel insert 260 provides a consistent return path and shielding geometry around a bend or turn between the channel shields 240A-248A and 240B-248B. The channel insert 260 can be secured between the upper channel shields 240A-248A and the lower channel shields 240B-248B using a press- or interference-fit, as one example. In some cases, a combination of one or more of mechanical fasteners, mechanical interlocks, adhesives, plastic welds, and other fastening approaches can additionally or alternatively be used to secure the channel insert 260 to the channel shields 240-248. The channel insert 262 can be secured between the lower channel shields 240B-248B, at one end of the lower channel shields 240B-248B, as also described below. The channel insert 262 can form part of the terminal foot 13 (see FIG. 1A) of the connector 10 and provide EMI shielding and a consistent return path geometry at the terminal foot 13.

The channel insert 260 includes a number of corner bumpers, such as the corner bumpers 260A-260C referenced in FIG. 2C, among others, in the example shown. The corner bumpers 260A-260C fit beside or between the channel shields 240-242 and provide channel corners between the upper channel shields 240A-242A and the lower channel shields 240B-242B. The corner bumpers 260A-260C extend between the sidewalls of the channel shields 240-242 and help to improve EMI shielding by establishing a consistent return path and shielding geometry all the way around the bend. Other corner bumpers of the channel insert 260 can also occupy other openings at corners between other channel shields in the wafer assembly 200. The channel insert 262 shown in FIG. 2C includes a number of tail bumpers, such as the tail bumpers 262A-262C, among others. The tail bumpers 262A-262C fit beside or between the lower channel shields 240B-242B at the tail ends of the lower channel shields 240B-242B. The tail bumpers 262A-262C, among others, provide additional shielding at the tail ends of the terminal conductors 220-228 and 230-232 in the row 210, at the terminal foot 13 of the connector 10 and provide a solderable surface to attach the shield structure to the PCB 20 (see FIG. 1B).

The channel inserts 260 and 262 can be formed using any suitable additive or subtractive manufacturing techniques, including molding, injection molding, printing, and other techniques. Outer surfaces of the channel inserts 260 and 262 can be selectively metalized or plated with a plating metal or metals for conductivity in some cases, and the channel inserts 260 and 262 can be embodied as plated plastic components. In one example, all exterior-facing outer surfaces of the channel inserts 260 and 262 are plated with a metal or metals for conductivity. In other cases, only certain surfaces or surface regions of the channel inserts 260 and 262 are plated. The plating facilitates the use of the channel inserts 260 and 262 as a common ground or drain connection in the wafer assembly 200, as well as a type of EMI shield.

When formed from a plastic or polymer, surfaces or surface regions of the channel inserts 260 and 262 can be etched in some cases and metalized or plated in a bath, barrel plated, plated by physical vapor deposition (PVD), plated by electroless plating, electroplating, sputter plating, ion plating, or other plating techniques or a combination thereof. The surfaces of the channel inserts 260 and 262 can be metalized or plated with copper, nickel, tin, silver, other plating metals, or combinations of plating metals. In another metallization approach, the material from which the channel inserts 260 and 262 are formed can include a laser direct structuring (LDS) additive. A laser beam can be used to activate the LDS additive over certain surfaces or surface areas of the channel inserts 260 and 262 for metallization. A subsequent metallization process can be performed by submerging the channel inserts 260 and 262 in a bath, and conductive metal plating can adhere to the activated surfaces or surface areas of the channel inserts 260 and 262. A number of different layers of metal, such as copper, nickel, tin, gold, or other plating metals or combinations thereof can be successively plated in that approach. Thus, the channel inserts 260 and 262 can also form part of the shielding and grounding network for the signal terminals in the connector 10. Because the channel inserts 260 and 262 can be plated and conductive, the channel inserts 260 and 262 can electrically couple (i.e., electrically “common”) potentials among the channel shields 240-248. In other cases, the channel inserts 260 and 262 can be formed using a diecast, molding, or related approach using a conductive material, such as a metal, metal alloy, or other conductive material.

The compliant shield inserts 270A-279A and 270B-279B and can be embodied as an elastic, expandible and compressible material. The compliant shield web 280 can also be embodied as an elastic, expandible and compressible material. The compliant shield web 280 and one or more of the compliant shield inserts 270A-279A can be integrally formed together as a single part or piece in some cases. The compliant shield web 280 and compliant shield inserts 270A-279A can be separated from each other in other cases. The compliant shield inserts 270-279 and the compliant shield web 280 can also be conductive, in addition to being expandible and compressible. As one example, the compliant shield inserts 270-279, the compliant shield web 280, or both can be embodied as a polyurethane foam multi-laminate including conductive materials, such as copper, nickel, or other conductive metals or materials. The compliant shield inserts 270-279, the compliant shield web 280, or both can be embodied as the P-SHIELD® brand PS-1323, PS-1768, or similar conductive foam, foam tape, or foam sheet manufactured by Polymer Science, Inc. of Monticello, Indiana, although other suitable types of conductive elastomeric or foam materials can be relied upon. As another example, the compliant shield inserts 270-279, the compliant shield web 280, or both can be embodied as a hyper-elastic material, such as silicone doped with conductive media, including the CHO-SEAL 1215 material of Parker Hannafin Corporation.

In some cases, a first subset of the compliant shield inserts 270-279 can be embodied as a first conductive foam, such as the PS-1323 conductive foam, and a second subset of the compliant shield inserts 270-279 can be embodied as a second conductive foam, such as the PS-1768 conductive foam. Thus, each of the compliant shield inserts 270-279 can be embodied or formed from the same type of conductive, compressible material in some cases. In other cases, two or more of the compliant shield inserts 270-279 can be formed from different types of materials.

The compliant shield inserts 270-279 are positioned beside or between the channel shields 240-248. More particularly, the compliant shield inserts 270A-279A are positioned beside or between channel sidewalls of the upper channel shields 240A-248A, and the compliant shield inserts 270B-279B are positioned beside or between channel sidewalls of the lower channel shields 240B-248B. The compliant shield inserts 270A-279A can extend beside or between the upper channel shields 240A-248A along the full length of the upper channel shields 240A-248A in one example. In other cases, the compliant shield inserts 270A-279A can extend along only a part or portion of the length of the upper channel shields 240A-248A. The compliant shield inserts 270A-279A can also extend into (e.g., occupy or fill the space in) the compliancy notches of the upper channel shields 240A-248A in some cases.

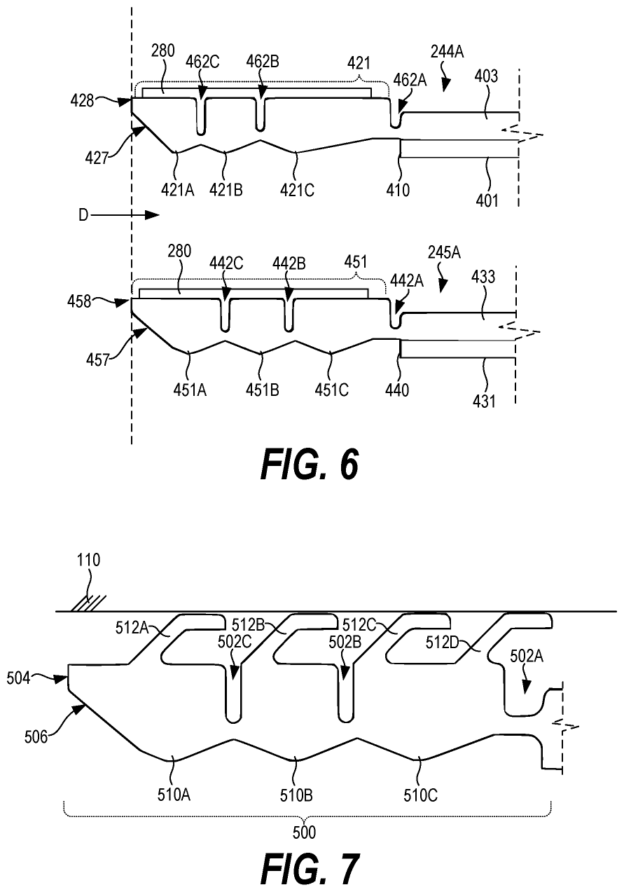

The compliant shield web 280 is positioned over and across the ground shield terminal walls of the upper channel shields 240A-248A. Referring to FIG. 2B, the compliant shield web 280 can be positioned in the region 290, over the edges of the ground shield terminal walls of the upper channel shields 240A-248A, when the wafer assembly 200 is assembled. The compliant shield web 280 can be formed as a web or matrix of conductive and elastic material. As depicted in FIG. 2B, the compliant shield web 280 includes rows and columns of the conductive and elastic material, with openings between the rows and columns. In other cases, the compliant shield web 280 can be formed as a full sheet of the conductive and elastic material that covers the entire region 290, and other formats are within the scope of the embodiments. The compliant shield web 280 can also occupy the space between the ground shield terminal walls of the upper channel shields 240A-248A and an inner surface of the housing 100, as described in further detail below with reference to FIG. 6.

The compliant shield inserts 270-279 and compliant shield web 280 electrically common potentials among the channel shields 240-248 and form part of a grounding network and EMI shield in the connector 10. The compliant shield inserts 270-279 and compliant shield web 280 can be secured to the channel shields 240-248 using adhesives, hot melting, hot staking, or hot welding, mechanical interferences or interlocking features, or using other approaches or combinations thereof. Additional aspects of the compliant shield inserts 270-279 and the compliant shield web 280 are described below.

Referring among FIGS. 2D and 2E, the wafer assembly 300 includes signal terminal conductors 320-328, 330, and 331 (also “signal terminals 320-328, 330, and 331”), among others, a power terminal conductor 332 (also “power terminal 332,” and collectively “terminals 320-328 and 330-332”), upper channel shields 340A-348A and lower channel shields 340B-348B (collectively “channel shields 340-348”), wafer molding inserts 350 and 351, channel inserts 360 and 362, compliant shield inserts 370A-379A and compliant shield inserts 370B-379B (collectively “compliant shield inserts 370-379”), and a compliant shield web 380. The compliant shield inserts 370-379 and compliant shield web 380 are examples of compliant shields, as referred to herein. The wafer assembly 300 is illustrated as a representative example in FIGS. 2D and 2E, and the size, number, shape, and other aspects of the components of the wafer assembly 300 can vary as compared to that shown.

The terminals 320-328 and 330-332 can be formed from a flat sheet of metal or other conductive material. In some cases, the sheet of metal can be plated with one or more plating metals. Each of the channel shields 340-348 can also be formed from a flat sheet of metal or other conductive material, which can be plated in some cases. Each of the channel shields 340-348 is bent or pressed into type of “U” or channel shape and includes a pair of ground shield terminal walls, as described in further detail below with reference to FIGS. 3A and 3B. The shape of the channel shields 340-348 can also vary as compared to that shown.

The terminals 320-328 and 330-332 can be formed in a row, extending alongside each other, at the same time from a single sheet of metal in one example. Each of the terminals 320-328 and 330-332 includes a lead or tip contact at one distal end (i.e., positioned in the front port opening 12 of the connector 10, as shown in FIG. 1A), a tail contact at another distal end (i.e., positioned at the terminal foot 13), and a terminal conductor body including a bend between the top contact and the tail contact. For example, as shown in FIG. 2D, the signal terminal conductor 328 includes a tip contact 328A and a tail contact 328B. The tail contacts of the terminals 320-328 and 330-332 can be formed as SMT tail contacts, as in the example shown, as through-hole (e.g., eye-of-needle) tail contacts, or as other types of tail contacts. However, in other examples, the connector 10 can incorporate bypass cables, and the terminal conductor body of the terminals 320-328 and 330-332 can be directly coupled to one or more twinax cables for signal bypass applications.

The signal terminal conductors 320-328, among others in the wafer assembly 300, can be arranged and used in pairs of terminal conductors to transfer high-speed differential signals. For example, the conductors 320 and 321 can be relied upon as a fourth pair of signal terminal conductors for communicating a fourth high-speed differential signal, the conductors 322 and 323 can be relied upon as a fifth pair of signal terminal conductors for communicating a fifth high-speed differential signal, the conductors 324 and 325 can be relied upon as a sixth pair of signal terminal conductors for communicating a sixth high-speed differential signal, and so on. The signal terminal conductors 330 and 331, among possibly others in the wafer assembly 300, can be relied upon as a pair of signal terminal conductors for communicating a second low-speed differential signal. The power terminal conductor 332 can be relied upon to source or sink power, for example, such as for sinking or sourcing a DC supply of power at 5V, 12V, or power at another potential.

The channel shields 340-348 form part of the shielding and grounding network for the signal terminals in the connector 10. Thus, the signal terminal conductors 320-328, 330, and 331, the power terminal conductor 332, and other terminal conductors of the wafer assembly 300 can be arranged with the channel shields 340-348. The terminal conductors 320-328 and 330-332 extend along and within the channels of the channel shields 340-348 in the wafer assembly 300. The pair of signal terminal conductors 320 and 321 shown in FIG. 2D, for example, are positioned and extend within the channel of the channel shield 340. In that arrangement, the channel shield 340 provides EMI shielding and a consistent current return path for the signal terminal conductors 320 and 321 and helps to reduce crosstalk and spurious signals between the signal terminal conductors 320 and 321 and other terminal conductors in the connector 10. In addition to EMI shielding, the channel shield 340 is designed to provide a return path sufficient to ensure suitable signal integrity for differential signals carried over the signal terminal conductors 320 and 321. The other channel shields 341-348 provide a similar purpose. For example, the pair of signal terminal conductors 322 and 323 are positioned and extend within the channel of the channel shield 341, the pair of signal terminal conductors 324 and 325 are positioned and extend within the channel of the channel shield 345, and so on. At the middle of the wafer assembly 300, the signal terminal conductors 330 and 331 and the power terminal conductor 332 are positioned and extend within the channel of the channel shield 344, which is wider than the other channel shields.

The wafer molding inserts 350 and 351 can be formed by injection molding. In one example, the terminal conductors 320-328 and 330-332, among others in the row 310, can be arranged and positioned in a mold along with the channel shields 340-348. The wafer molding inserts 350 and 351 can then be formed by the injection of a plastic, such as LCP or another insulating material(s), into the mold. The insulating material can flow around the terminal conductors 320-328 and 330-332 within the mold, to form the wafer molding inserts 350 and 351.

The wafer molding inserts 350 and 351 serve a number of purposes in the wafer assembly 300. The wafer molding inserts 350 and 351 secure the terminal conductors 320-328 and 330-332 in place relative to each other. The wafer molding inserts 350 and 351 also electrically isolate the terminal conductors 320-328 and 330-332 from each other. When formed, the insulating material of the wafer molding inserts 350 and 351 can also flow through, or otherwise be inserted through, openings or apertures in the channel shields 340-348, and a heat staking process can be used to form staking caps of the wafer molding inserts 350 and 351. The staking caps locate and secure the wafer molding inserts 350 and 351 with the channel shields 340-348, as described in further detail below. Thus, when formed, the wafer molding inserts 350 and 351 secure the terminal conductors 320-328 and 330-332 within the channel shields 340-348, electrically isolate the terminal conductors 320-328 and 330-332 from each other, and electrically isolate the terminal conductors 320-328 and 330-332 from the channel shields 340-348.

The channel inserts 360 and 362 can be separately formed from a plastic or polymer, such as LCP, PE, PTFE, fluoropolymer, or other plastic or insulating material(s) in one example and assembled to the channel shields 340-348. The channel inserts 360 and 362 can also be formed from moldable metal material, using a die-cast, metal-injected molding, additive manufacturing methodology, or related approach. The channel insert 360 is positioned and secured between the upper channel shields 340A-348A and the lower channel shields 340B-348B, and the channel insert 360 provides a consistent return path and shielding geometry around a bend or turn between the channel shields 340A-348A and 340B-348B. The channel insert 360 can be secured between the upper channel shields 340A-348A and the lower channel shields 340B-348B using a press- or interference-fit, as one example. In some cases, a combination of one or more of mechanical fasteners, mechanical interlocks, adhesives, plastic welds, and other fastening approaches can additionally or alternatively be used to secure the channel insert 360 to the channel shields 340-348. The channel insert 362 can be secured between the lower channel shields 340B-348B, at one end of the lower channel shields 340B-348B, as also described below. The channel insert 362 can form part of the terminal foot 13 (see FIG. 1A) of the connector 10 and provide EMI shielding and a consistent return path geometry at the terminal foot 13.

The channel insert 360 includes a number of channel bumpers, such as the channel bumpers 360A-360C, among others, in the example shown. The channel bumpers 360A-360C fit beside or between the upper channel shields 340A-341A at the corners between the upper channel shields 340A-341A and the lower channel shields 340B-341B. Overall, the channel insert 360 occupies space or openings between sidewalls of the channel shields 340-348, at corners between the upper channel shields 340A-348A and the lower channel shields 340B-348B, and improves EMI shielding by establishing a consistent return path and shielding geometry all the way around the bend. The channel insert 362 includes a number of tail bumpers, such as the tail bumpers 362A-362C, among others. The tail bumpers 362A-362C fit beside or between the lower channel shields 340B-342B at the tail ends of the lower channel shields 340B-342B. The tail bumpers 362A-362C, among others, provide additional shielding at the tail ends of the terminal conductors 320-328 and 330-332 in the row 310, at the terminal foot 13 of the connector 10 and provide a solderable surface to attach the shield structure to the PCB 20 (see FIG. 1B).

The channel inserts 360 and 362 can be formed using any suitable additive or subtractive manufacturing techniques, including molding, injection molding, printing, and other techniques. Similar to the channel inserts 260 and 262 of the wafer assembly 200, the outer surfaces of the channel inserts 360 and 362 of the wafer assembly 300 can be selectively metalized or plated with a plating metal or metals for conductivity in some cases. In one example, all exterior-facing outer surfaces of the channel inserts 360 and 362 are plated with a metal or metals for conductivity. In other cases, only certain surfaces or surface regions of the channel inserts 360 and 362 are plated. The plating facilitates the use of the channel inserts 360 and 362 as a common ground or drain connection in the wafer assembly 300, as well as a type of EMI shield. In other cases, the channel inserts 360 and 362 can be formed using a diecast, molding, or related approach using a conductive material, such as a metal, metal alloy, or other conductive material.

The compliant shield inserts 370A-379A and 370B-379B and can be embodied as an elastic, expandible and compressible material. The compliant shield web 380 can also be embodied as an elastic, expandible and compressible material. The compliant shield web 380 and one or more of the compliant shield inserts 370A-379A can be integrally formed together as a single part or piece in some cases. The compliant shield web 380 and compliant shield inserts 370A-379A can be separated from each other in other cases. The compliant shield inserts 370-379 and the compliant shield web 380 can also be conductive, in addition to being expandible and compressible. As one example, the compliant shield inserts 370-379, the compliant shield web 380, or both can be embodied as a polyurethane foam multi-laminate including conductive materials, such as copper, nickel, or other conductive metals or materials. The compliant shield inserts 370-379, the compliant shield web 380, or both can be embodied as the P-SHIELD® brand PS-1323, PS-1768, or similar conductive foam, foam tape, or foam sheet manufactured by Polymer Science, Inc. of Monticello, Indiana, although other suitable types of conductive elastomeric or foam materials can be relied upon. As another example, the compliant shield inserts 370-379, the compliant shield web 380, or both can be embodied as a hyper-elastic material, such as silicone doped with conductive media, including the CHO-SEAL 1215 material of Parker Hannafin Corporation.

In some cases, a first subset of the compliant shield inserts 370-379 can be embodied as a first conductive foam, such as the PS-1323 conductive foam, and a second subset of the compliant shield inserts 370-379 can be embodied as a second conductive foam, such as the PS-1768 conductive foam. Thus, each of the compliant shield inserts 370-379 can be embodied or formed from the same type of conductive, compressible material in some cases. In other cases, two or more of the compliant shield inserts 370-379 can be formed from different types of materials.

The compliant shield inserts 370-379 are positioned beside or between the channel shields 340-348. More particularly, the compliant shield inserts 370A-379A are positioned beside or between channel sidewalls of the upper channel shields 340A-348A, and the compliant shield inserts 370B-379B are positioned beside or between channel sidewalls of the lower channel shields 340B-348B. The compliant shield inserts 370A-379A can extend beside or between the upper channel shields 340A-348A along the full length of the upper channel shields 340A-348A in one example. In other cases, the compliant shield inserts 370A-379A can extend along only a part or portion of the length of the upper channel shields 340A-348A. The compliant shield inserts 370A-379A can also extend into the compliancy notches of the upper channel shields 340A-348A in some cases.

The compliant shield web 380 is positioned over and across the ground shield terminal walls of the upper channel shields 340A-348A. Referring to FIG. 2D, the compliant shield web 380 can be positioned in the region 390, over the edges of the ground shield terminal walls of the upper channel shields 340A-348A, when the wafer assembly 300 is assembled. The compliant shield web 380 can be formed as a web or matrix of conductive and elastic material. As depicted in FIG. 2D, the compliant shield web 380 includes rows and columns of the conductive and elastic material, with openings between the rows and columns. In other cases, the compliant shield web 380 can be formed as a full sheet of the conductive and elastic material that covers the entire region 390, and other formats are within the scope of the embodiments.

The compliant shield inserts 370-379 and compliant shield web 380 electrically common potentials among the channel shields 340-348 and form part of a grounding network and EMI shield in the connector 10. The compliant shield inserts 370-379 and compliant shield web 380 can be secured to the channel shields 340-348 using adhesives, hot melting or welding, mechanical interferences or interlocking features, or using other approaches or combinations thereof. Additional aspects of the compliant shield inserts 370-379 and the compliant shield web 380 are described below.

FIG. 3A illustrates a top-down perspective view of the upper channel shields 244A and 245A and the lower channel shields 244B and 245B of the wafer assembly 200 shown in FIG. 2A. FIG. 3B illustrates a bottom-up perspective view of the upper channel shields 244A and 245A and the lower channel shields 244B and 245B. Each of the channel shields 244A and 244B, among others in the connector 10, provide a type of shielding channel. As one example, the shielding channel “C” is formed between the channel floor walls and channel sidewalls of the channel shield 244A, as shown in FIG. 3A. Each of the channel shields in the wafer assemblies 200 and 300 provides a similar type of shielding channel. When the wafer assembly 200 is fully assembled, as depicted in FIG. 2A, the signal terminal conductors 230 and 231 and the power terminal conductor 232 are positioned within and extend along the channel “C” of the upper channel shield 244A. The signal terminal conductors 230 and 231 and the power terminal conductor 232 also extend along a similar channel of the lower channel shield 244B. In a similar way, the signal terminal conductors 224 and 225 are positioned within and extend along channels of the channel shields 245A and 254B. FIGS. 3A and 3B omit all terminal conductors, however, so that the features of the channel shields 244A, 244B, 245A, and 245B are visible and not obscured.

The channel shields 244A, 244B, 245A, and 245B shown in FIGS. 3A and 3B are representative examples of the channel shields 240-248 in the wafer assembly 200 and the channel shields 340-348 in the wafer assembly 300. Each of the channel shields 240-248 and 340-348 includes one or more channel floor walls, one or more channel sidewalls, and one or more ground shield terminal walls, similar to those described below in connection with the channel shields 244A, 244B, 245A, and 245B. The channel shields 244A and 244B are centrally positioned in the wafer assembly 200 and are relatively larger (e.g., wider) than the channel shields 245A and 245B and other channel shields in the wafer assembly 200. Similarly, the channel shields 344A and 344B are centrally positioned in the wafer assembly 300 and are relatively larger than the other channel shields in the wafer assembly 300.

Referring among FIGS. 3A and 3B, the upper channel shield 244A includes a channel floor wall 401, a first channel sidewall 402, and a second channel sidewall 403. The lower channel shield 244B includes a second channel floor wall 404, a first channel sidewall 405, and a second channel sidewall 406. The channel sidewalls 402 and 403 can be referred to as a pair of channel sidewalls of the upper channel shield 244A, and the channel sidewalls 405 and 406 can be referred to as a pair of channel sidewalls of the lower channel shield 244B. The channel floor wall 401 of the upper channel shield 244A extends in a direction and plane that is perpendicular to the channel floor wall 404 of the lower channel shield 244B in the example shown. The channel floor walls 401 and 404 can also extend at other angles with respect to each other.

The upper channel shield 244A also includes a first ground shield terminal wall 420 and a second ground shield terminal wall 421. The ground shield terminal walls 420 and 421 can be referred to as a pair of ground shield terminal walls, ground shield beams, or ground shield terminals of the upper channel shield 244A and the wafer assembly 200. The first ground shield terminal wall 420 is an extension of the first channel sidewall 402. The first ground shield terminal wall 420 extends beyond an end edge 410 of the channel floor wall 401. A compliancy notch 412A is formed along an upper edge of the upper channel shield 244A, at a location between the first channel sidewall 402 and the first ground shield terminal wall 420. The first ground shield terminal wall 420 may also include additional compliancy notches 412B and 412C, which are described in further detail below.

The second ground shield terminal wall 421 is an extension of the second channel sidewall 403. The second ground shield terminal wall 421 extends beyond an end edge 410 of the channel floor wall 401. A compliancy notch 414A is formed along another upper edge of the upper channel shield 244A, at a location between the second channel sidewall 403 and the second ground shield terminal wall 421. The second ground shield terminal wall 421 may also include additional compliancy notches, which are described in further detail below.

The upper channel shield 245A includes a channel floor wall 431, a first channel sidewall 432, and a second channel sidewall 433. The lower channel shield 245B includes a channel floor wall 434, a first channel sidewall 435 (see FIG. 3B), and a second channel sidewall 436. The channel sidewalls 432 and 433 can be referred to as a pair of channel sidewalls of the upper channel shield 245A, and the channel sidewalls 435 and 436 can also be referred to as a pair of channel sidewalls of the lower channel shield 245B. The channel floor wall 431 of the upper channel shield 245A extends in a direction and plane that is perpendicular to the channel floor wall 434 of the lower channel shield 245B in the example shown. The channel floor walls 431 and 434 can also extend at other angles with respect to each other.

The upper channel shield 245A also includes a first ground shield terminal wall 450 and a second ground shield terminal wall 451. The ground shield terminal walls 450 and 451 can also be referred to as a pair of ground shield terminal walls of the wafer assembly 200. The first ground shield terminal wall 450 is an extension of the first channel sidewall 432. The first ground shield terminal wall 450 extends beyond an end edge 440 of the channel floor wall 431. The second ground shield terminal wall 451 is an extension of the second channel sidewall 433. The second ground shield terminal wall 451 extends beyond an end edge 440 of the channel floor wall 431. The first channel sidewall 432 and the second channel sidewall 433 can extend in parallel planes in some cases, and the ground shield terminal walls 450 and 451 can also extend in parallel planes in some cases. However, one or both of the first channel sidewall 432 and the second channel sidewall 433 can also extend at angles and in planes that would intersect with each other in some cases. One or both of the ground shield terminal walls 450 and 451 can also extend at angles and in planes that would intersect with each other in some cases. Both the ground shield terminal walls 450 and 451 may include compliancy notches, similar to the compliancy notches in the ground shield terminal walls 420 and 421.

The channel shields 244A, 244B, 245A, and 245B, among others in the connector 10, form part of the shielding and grounding network for the signal terminals in the connector 10. The ground shield terminal walls 420, 421, 450, 451 of the upper channel shields 244A and 245A are relied upon in place of (e.g., rather than) ground or drain terminal conductors in the connector 10. None of the terminal conductors 220-228 and 230-232 in the wafer assembly 200 nor the terminal conductors 320-328 and 330-332 in the wafer assembly 300 are relied upon as ground, drain, or shield terminal conductors, as may be common in other connectors. Instead, the ground shield terminal walls 420, 421, 450, and 451 provide robust shielding walls and offer better EMI rejection among pairs of signal terminal conductors in the connector 10.

Each of the ground shield terminal walls 420, 421, 450, 451 comprises multi-point contacts and can be referred to as a multi-point contact ground shield terminal wall. For example, three (3) point contacts 451A-451C of the ground shield terminal wall 451 are referenced in FIG. 3A. The ground shield terminal walls described herein are not limited to having any particular number of point contacts, however, and ground shield terminal walls having one, two, three, four, five, or more point contacts are within the scope of the embodiments. Additional examples of ground shield terminal walls having multi-point contacts are described below with reference to FIG. 6.

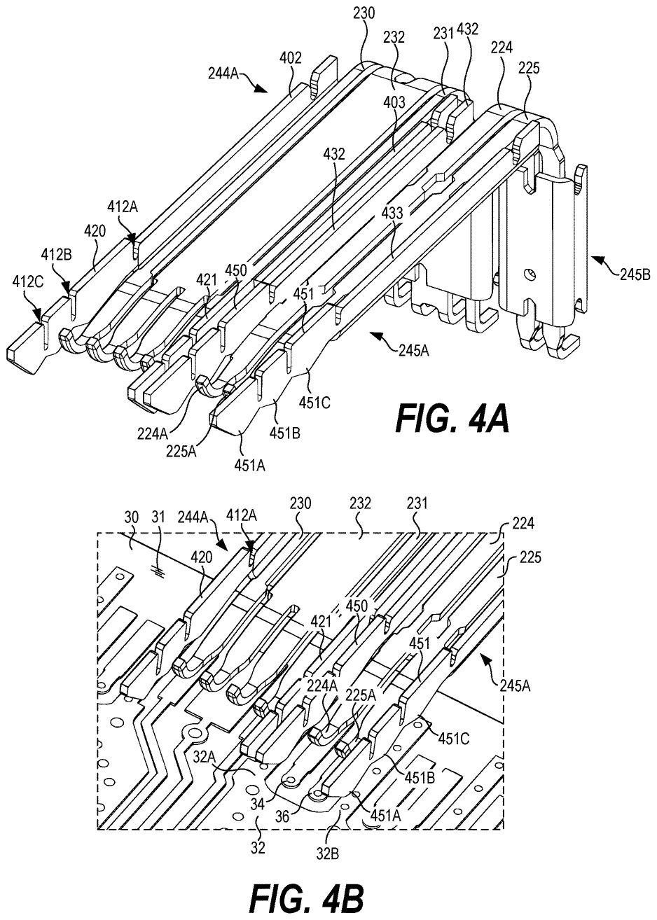

FIG. 4A illustrates a top-down perspective view of the upper channel shields 244A and 245A, the lower channel shields 244B and 245B, and the terminal conductors 224, 225, and 230-232 of the wafer assembly 200 shown in FIG. 2A. The signal terminal conductors 230 and 231 and the power terminal conductor 232 are positioned within and extend along the channel “C” (see FIG. 3A) of the upper channel shield 244A. Similarly, the signal terminal conductors 224 and 225 are positioned within and extend along a channel of the upper channel shield 245A.

The tip contacts 224A and 225A of the signal terminal conductors 224 and 225, respectively, are also referenced in FIG. 4A. The tip contacts 224A and 225A are positioned between the ground shield terminal walls 450 and 451 of the upper channel shield 245A. The ground shield terminal walls 450 and 451 flank both sides of the tip contacts 224A and 225A and provide EMI shielding and a consistent current return path between the signal terminal conductors 224 and 225 and other terminal conductors in the connector 10. The pair of channel sidewalls 432 and 433 of the upper channel shield 245A also provide EMI shielding between the signal terminal conductors 224 and 225 and other terminal conductors in the connector 10.

FIG. 4B illustrates another top-down perspective view of the upper channel shields 244A and 245A and the terminal conductors 224, 225, and 230-232 of the wafer assembly 200, along with the board card edge interface 30. The board card edge interface 30 can be embodied as a PCB. The board card edge interface 30 is inserted between the rows 210 and 310 (see FIG. 1B) when inserted into the front port opening 12 of the connector 10. The board card edge interface 30 includes a conductive ground plane 32 formed over a top surface 31 of the board card edge interface 30. The ground plane 32 includes ground contact fingers 32A and 32B. The board card edge interface 30 also includes conductive signal contact pads 34 and 36 formed over the top surface 31 of the board card edge interface 30, among other features. The ground contact fingers 32A and 32B and signal contact pads 34 and 36 can be embodied as separated contact pads or regions of a metal layer formed over the top surface 31 of the board card edge interface 30.

FIG. 4B illustrates how the tip contacts 224A and 225A of the signal terminal conductors 224 and 225, respectively, contact and rest upon exposed surfaces of the signal contact pads 34 and 36. The tip contacts 224A and 225A are positioned between the ground shield terminal walls 450 and 451 of the channel shield 245 over the board card edge interface 30.

FIG. 4B also depicts how the ground shield terminal walls 450 and 451 contact and rest upon exposed surfaces of the ground contact fingers 32A and 32B of the ground plane 32. For The point contacts 451A-451C of the ground shield terminal wall 451 contact and rest upon the ground contact finger 32B of the ground plane 32. Point contacts of the ground shield terminal wall 450 also contact and rest upon the ground contact finger 32A of the ground plane 32. The ground shield terminal walls 450 and 451 also flank both sides of the tip contacts 224A and 225A and extend further than the tip contacts 224A and 225A in the configuration shown in FIG. 4B and provide EMI shielding between the signal terminal conductors 224 and 225 and other terminal conductors in the connector 10.

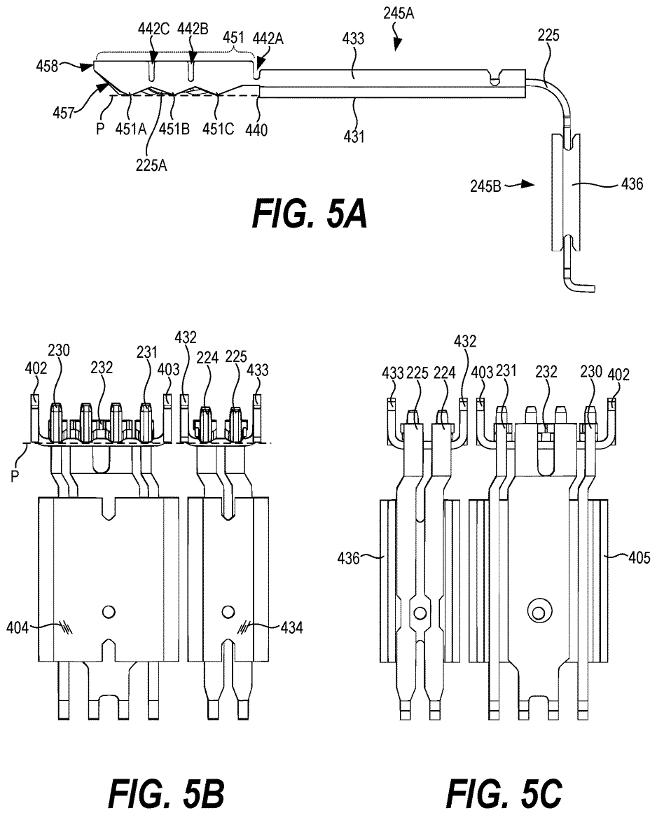

FIG. 5A illustrates a side view, FIG. 5B illustrates a front view, and FIG. 5C illustrates a back view of the channel shields 244 and 245 and the terminal conductors 225, 224, and 230-231 of the wafer assembly 200. Additional features of the ground shield terminal wall 451 of the upper channel shield 245A are shown in FIG. 5A. FIG. 5A shows a compliancy notch 442A formed between the channel sidewall 433 and the ground shield terminal wall 451 of the upper channel shield 245A. The ground shield terminal wall 451 may also include additional compliancy notches 442B and 442C, a tip end 458, and an angled front edge 457. The point contacts 451A-451C of the ground shield terminal wall 451 are also shown in FIG. 5A.

The shape, size, and features of the ground shield terminal wall 451 are presented as a representative example in FIG. 5A, and the ground shield terminal walls in the wafer assembly 200 can vary as compared to that shown. For example, the length of the ground shield terminal wall 451, as measured between the end edge 440 and the tip end 458 of the upper channel shield 245A, can be larger or smaller than that shown. As shown in FIG. 5A, the compliancy notches 442A-442C are formed in the ground shield terminal wall 451 of the upper channel shield 245A, along the top or upper edge of the ground shield terminal wall 451, at locations between the point contacts 451A-451C of the ground shield terminal wall 451. The number and positions of the compliancy notches 442A-442C, the number and positions of the point contacts 451A-451C, the angle of the angled front edge 457, and other aspects of the ground shield terminal wall 451 can vary as compared to that shown. Each of the ground shield terminal walls of the channel shields 240-248 and 340-348 in the connector 10 can be similar to (or the same as) each other in some embodiments. However, in other cases, the wafer assemblies 200 and 300 can include different types (e.g., shapes, sizes, styles, etc.) of ground shield terminal walls, as also described below.

The wafer assemblies 200 and 300 are designed such that the tips of the terminal conductors and ground shield terminal walls in the rows 210 and 310 (see FIGS. 1A and 1B) will contact and rest upon signal and ground contact pads, respectively, formed on the top and bottom surfaces of the board card edge interface 30, when the board card edge interface 30 is inserted into the front port opening 12 of the connector 10. Thus, the point contacts 451A-451C of the ground shield terminal wall 451 are configured to intersect with (e.g., contact, overlap with, or occupy) a contact tip plane “P” when the board card edge interface 30 is inserted between the rows 210 and 310 of the connector 10. The contact tip plane “P” extends in the same plane as the channel floor wall 431 of the upper channel shield 245A in the example shown, but the connector 10 can be designed such that the contact tip plane “P” is located at other positions.

The tip contact 225A of the signal terminal conductor 225 is also configured to intersect the contact tip plane “P” when the board card edge interface 30 is inserted between the rows 210 and 310 of the connector 10. The contact tip plane “P” can be representative of the top surface 31 of the board card edge interface 30 or top surfaces of contact pads over the top surface 31.

FIG. 6 illustrates side views of the upper channel shields 244A and 245A. More particularly, FIG. 6 illustrates a side view of the ground shield terminal wall 421 of the upper channel shield 244A and the ground shield terminal wall 451 of the upper channel shield 245A. The ground shield terminal wall 421 includes compliancy notches 462A-462C, a tip end 428, an angled front edge 427, and point contacts 421A-421C. The ground shield terminal wall 451 includes the compliancy notches 442A-442C, the tip end 458, the angled front edge 457, and the point contacts 451A-451C. The ground shield terminal walls 421 and 451 are depicted as representative examples in FIG. 6. The positions of the point contacts 421A-421C and 451A-451C on the ground shield terminal walls 421 and 451 are different than each other, as described below. However, the number and positions of the point contacts, the number and positions of the compliancy notches, and other aspects of the ground shield terminal walls of the channel shields in both the wafer assemblies 200 and 300 can vary as compared to that shown and described below. The wafer assemblies 200 and 300 can also include other ground shield terminal walls with point contact positions that are different than those shown in FIG. 6.

In the example shown in FIG. 6, the positions of the point contacts 421A-421C on the ground shield terminal wall 421 are different than the positions of the point contacts 451A-451C on the ground shield terminal wall 451. For example, measured in the direction “D,” the point contact 421A on the ground shield terminal wall 421 is closer to the tip ends 458 and 428 than the point contact 451A on the ground shield terminal wall 451. Also, measured in the direction “D,” the point contact 421B on the ground shield terminal wall 421 is closer to the tip ends 458 and 428 than the point contact 451B on the ground shield terminal wall 451. The point contacts 451A-451C are staggered in position as compared to the point contacts 421A-421C. Among the upper channel shields 240A-248A in the wafer assembly 200, the positions of the point contacts on the shields can alternate between every other one of the upper channel shields 240A-248A, in one example, but the positions of the point contacts and vary or alternate in other ways.

The compliancy notches 462A-462C of the ground shield terminal wall 421 and the compliancy notches 442A-442C of the ground shield terminal wall 451 provide independent deflection zones in the ground shield terminal walls 421 and 451. The independent deflection zones permit the point contacts 421A-421C to move independently as compared to each other, at least to some extent. The independent deflection zones also permit the point contacts 451A-451C to move independently as compared to each other.

FIG. 6 also illustrates the compliant shield web 280 over the ground shield terminal wall 421 and over the ground shield terminal wall 451. The compliant shield web 280 is positioned over and across the ground shield terminal walls of all the upper channel shields 240A-248A. The compliant shield web 280 is also positioned between the ground shield terminal walls of the upper channel shields 240A-248A and inner surfaces of the front port 110 of the housing 100 (see FIG. 1). The compliant shield web 280 can, through expansion, apply a pressure or force against the ground shield terminal walls of the upper channel shields 240A-248A, which can result in additional contact pressure or force of the point contacts against contact pads on the board card edge interface 30.

FIG. 7 illustrates a side view of another example ground shield terminal wall 500 of another channel shield according to various embodiments of the present disclosure. The ground shield terminal wall 500 can be implemented on any or all of the channel shields 240-248 and 340-348 in the wafer assemblies 200 and 300. The ground shield terminal wall 500 includes compliancy notches 502A-502C, a tip end 504, an angled front edge 506, and point contacts 510A-510C. The number and positions of the point contacts 510A-510C, the compliancy notches 502A-502C, and other aspects of the ground shield terminal wall 500 can vary as compared to that shown.

The compliancy notches 502A-502C of the ground shield terminal wall 500 provide independent deflection zones for the ground shield terminal wall 500. The independent deflection zones permit the point contacts 510A-510C to move independently as compared to each other, at least to some extent. Each deflection zone of the ground shield terminal wall 500 also includes one or more cantilever spring beams extending from an upper edge. Example cantilever spring beams 512A-512D are shown in FIG. 7. The cantilever spring beams 512A-512D can contact an inner surface of the front port 110 of the housing 100, as shown in FIG. 7 (see also FIG. 1), particularly when the board card edge interface 30 is inserted into the connector 10. Based on spring contact with the inner surface of the front port 110, the cantilever spring beams 512A-512D can apply a downward pressure or force of the point contacts 510A-510C against contact pads on the board card edge interface 30. The number and positions of the cantilever spring beams 512A-512D can vary as compared to that shown. In one example, each independent deflection zone of the ground shield terminal wall 500 includes at least one cantilever spring beam, but any given deflection zone can also include zero, one, two, or more cantilever spring beams.

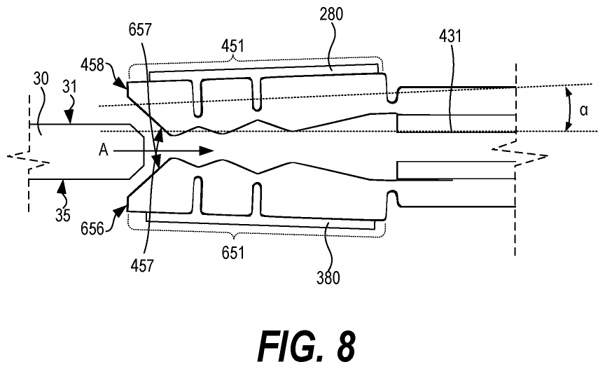

FIG. 8 illustrates another side view of the ground shield terminal wall 451 of the upper channel shield 245A and the board card edge interface 30. The ground shield terminal wall 451 includes the tip end 458 and the angled front edge 457. The board card edge interface 30 includes top and bottom surfaces 31 and 35. FIG. 8 also illustrates a side view of the upper channel shield 345A of the lower wafer assembly 300. The upper channel shield 345A includes a ground shield terminal wall 651 with a tip end 656 and an angled front edge 657.

The board card edge interface 30 is being inserted in the direction “A” and between the ground shield terminal walls 451 and 651 in FIG. 6. Before the board card edge interface 30 is inserted into the connector 10, both the ground shield terminal walls 451 and 651 are angled. For example, the ground shield terminal walls 451 extends at the angle α shown in FIG. 8, with respect to the extension of the channel floor wall 431 of the upper channel shield 245A. The ground shield terminal walls 651 extends at an angle in a similar way. Thus, the upper channel shields 245A and 345A, among others in the connector 10, are designed with ground shield terminal walls that extend at an angle, such as the angle α, as compared to the floor walls and sidewalls of the channel shields.

As the board card edge interface 30 is inserted into the connector 10, the angled front edges 457 and 657 will contact the side edge of the board card edge interface 30, and the board card edge interface 30 will push the ground shield terminal walls 451 and 651 apart from each other. The contact points of the ground shield terminal walls 451 and 651 will wipe across the top and bottom surfaces 31 and 35, respectively, of the board card edge interface 30, as it is further inserted further in the direction “A”. The compliancy notches of the ground shield terminal walls 451 and 651 are designed to permit some bending and rotating of the ground shield terminal walls 451 and 651 during this insertion process. As the contact points of the ground shield terminal walls 451 and 651 wipe across the top and bottom surfaces 31 and 35 of the board card edge interface 30, the compliant shield webs 280 and 380 can also be compressed to some extent against the inner surfaces of the front port 110 of the housing 100 (see FIG. 1).

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a housing comprising a slot for insertion of a board card edge interface; and
a wafer assembly positioned in the housing, the wafer assembly comprising a channel shield and a pair of signal terminals that extend along a channel of the channel shield, the channel shield comprising a channel floor wall, a pair of channel sidewalls, and a pair of multi-point contact ground shield terminal walls.

2. The connector according to claim 1, wherein contact tip surfaces of the pair of signal terminals and contact point surfaces of the pair of multi-point contact ground shield terminal walls intersect a single contact tip plane when the board card edge interface is inserted into the slot of the housing.

3. The connector according to claim 1, wherein the channel of the channel shield extends between the pair of sidewalls and over the channel floor.

4. The connector according to claim 1, wherein the pair of multi-point contact ground shield terminal walls of the channel shield extend beyond an end edge of the channel floor wall.

5. The connector according to claim 1, further comprising a compliant shield web positioned over and across the pair of multi-point contact ground shield terminal walls.

6. The connector according to claim 5, wherein the compliant shield web comprises a conductive foam.

7. The connector according to claim 1, further comprising a compliant shield insert that extends along a channel sidewall among the pair of channel sidewalls.

8. The connector according to claim 7, wherein the compliant shield insert comprises conductive foam.

9. The connector according to claim 1, wherein the channel shield comprises at least one notch positioned along at least one multi-point contact ground shield terminal wall among the pair of multi-point contact ground shield terminal walls.

10. The connector according to claim 1, wherein the channel shield comprises at least one cantilever spring beam extending from an upper edge of the pair of multi-point contact ground shield terminal walls.

11. The connector according to claim 1, further comprising:
a second channel shield comprising a second pair of multi-point contact ground shield terminal walls, wherein:
the pair of multi-point contact ground shield terminal walls of the channel shield comprises a first plurality of point contacts at first locations; and
the second pair of multi-point contact ground shield terminal walls of the second channel shield comprises a second plurality of point contacts at second locations different than the first locations.

12. A connector, comprising:
a housing; and
a wafer assembly positioned in the housing, the wafer assembly comprising a channel shield and a pair of signal terminals that extend along a channel of the channel shield, the channel shield comprising a pair of multi-point contact ground shield terminal walls, wherein:
contact tip surfaces of the pair of signal terminals and of the pair of multi-point contact ground shield terminal walls are configured to intersect a single contact tip plane when a board card edge interface is inserted into the housing.

13. The connector according to claim 12, wherein:
the channel shield further comprises a channel floor wall and a pair of channel sidewalls; and
the channel of the channel shield extends between the pair of sidewalls and over the channel floor.

14. The connector according to claim 13, wherein the pair of multi-point contact ground shield terminal walls of the channel shield extend beyond an end edge of the channel floor wall.

15. The connector according to claim 12, further comprising a compliant shield web positioned over and across the pair of multi-point contact ground shield terminal walls.

16. The connector according to claim 12, further comprising a compliant shield insert that extends along a channel sidewall of the channel shield.

17. The connector according to claim 12, wherein the channel shield comprises at least one notch positioned along at least one multi-point contact ground shield terminal wall among the pair of multi-point contact ground shield terminal walls.

18. A wafer assembly, comprising:
a channel shield comprising a channel floor wall, a pair of channel sidewalls, and a pair of multi-point contact ground shield terminal walls; and
a pair of signal terminals that extend along a channel of the channel shield, wherein:
contact tip surfaces of the pair of signal terminals and contact point surfaces of the multi-point contact ground shield terminal walls are configured to intersect a single contact tip plane.

19. The wafer assembly according to claim 18, further comprising a compliant shield web positioned over and across the pair of multi-point contact ground shield terminal walls.

20. The wafer assembly according to claim 18, further comprising a compliant shield insert that extends along a channel sidewall among the pair of channel sidewalls.
